(19) United States
(12) Patent Application Publication
(10) Pub. No.: US 2013/0286213 A1
(43) Pub. Date: Oct. 31, 2013

(54) METHOD, DEVICE AND SYSTEM FOR DETERMINING THE PRESENCE OF VOLATILE ORGANIC COMPOUNDS (VOC) IN VIDEO

(71) Applicants: Ahmet Enis Cetin, Ankara (TR); Beheet Ugur Toreyin, Ankara (TR)

(72) Inventors: Ahmet Enis Cetin, Ankara (TR); Beheet Ugur Toreyin, Ankara (TR)

(73) Assignee: DELACOM DETECTION SYSTEMS, LLC, Sarasota, FL (US)

(21) Appl. No.: 13/825,005

(22) PCT Filed: Jan. 19, 2011
(86) PCT No.: PCT/US2011/021780

§ 371 Date: Jul. 15, 2013

Related U.S. Application Data
(60) Provisional application No. 61/296,474, filed on Jan. 19, 2010.

(51) Int. Cl. H04N 5/33

(52) U.S. Cl. CPC H04N 5/332
USPC 348/164

(57) ABSTRACT

A video based method to detect volatile organic compounds (VOC) leaking out of components used in chemical processes in petrochemical refineries. Leaking VOC plume from a damaged component has distinctive properties that can be detected in realtime by an analysis of images from a combination of infrared and optical cameras. Particular VOC vapors have unique absorption bands, which allow these vapors to be detected and distinguished. A method of comparative analysis of images from a suitable combination of cameras, each covering a range in the IR or visible spectrum, is described. VOC vapors also cause the edges present in image frames to loose their sharpness, leading to a decrease in the high frequency content of the image. Analysis of image sequence frequency data from visible and infrared cameras enable detection of VOC plumes. Analysis techniques using adaptive background subtraction, sub-band analysis, threshold adaptation, and Markov modeling are described.

### BACKGROUND OF THE INVENTION

1. Field of the Invention

The present invention generally relates to the prophylactic detection of impending chemical volatility, and in particular to use of imaging techniques to detect the presence of volatile organic compounds outside a containment system.

2. Background Description

Petroleum refineries and organic chemical manufacturers periodically inspect leaks of volatile organic compounds (VOC) from equipment components such as valves, pumps, compressors, flanges, connectors, pump seals, etc. as described in L. Zhou, and Y. Zeng, “Automatic alignment, of infrared video frames for equipment leak detection,” Analytica Chimica Acta, Elsevier, v. 584/1, pp. 223-227, 2007 (“Zhou 2007”). Although Zhou mentions the use of IR imaging for VOC detection the article fails to mention the use of multiple cameras to identify the nature and content of the gas leak. Common practice for inspection is to utilize a portable flame ionization detector (FID) sniffing the seal around the components for possible leaks, as indicated by the U.S. Environmental Protection Agency in “Protocol for Equipment Leak Emission Estimates,” EPA-453/R-95-017, November 1995. A single facility typically has hundreds of thousands of such components.

FIDs are broadly used for detection of leakage of volatile organic compounds (VOC) in various equipment installed at oil refineries and factories of organic chemicals. For example, U.S. Pat. No. 5,445,795 filed on Nov. 17, 1993 describes “Volatile organic compound sensing devices” used by the United States Army. Another invention by the same inventor, U.S. Patent Application No. 2005/286927, describes a “Volatile organic compound detector.” However, FID based monitoring approaches turns out to be tedious work with high labor costs even if the tests are carried out on as limited a frequency as quarterly.

Several optical imaging based methods are proposed in the literature for VOC leak detection as a cost-effective alternative, as described in ENVIRON, 2004: “Development of Emissions Factors and/or Correlation Equations for Gas Leak Detection, and the Development of an EPA Protocol for the Use of a Gas-imaging Device as an Alternative or Supplement to Current Leak Detection and Evaluation Methods,” Final Rep. Texas Council on Env. Tech. and the Texas Comm. on Env. Quality, October, 2004, and M. Lev-On, H. Taback, D. Epperson, J. Siegell, L. Gilmer, and K. Ritterf, “Methods for quantification of mass emissions from leaking process equipment when using optical imaging for leak detection,” Environmental Progress, Wiley, v.25/1, pp. 49-55, 2006. In these approaches, infra-red (IR) cameras operating at a predetermined wavelength band with strong VOC absorptions are used for leak detection.

In other contexts it has been shown that fast Fourier transforms can be used to detect the peaks inside a frequency domain. For example, in the video-based fire detection system developed by Fastcom, temporal fast Fourier transforms were computed for the boundary pixels of objects, as described in R. T. Collins, A. J. Lipton, T. Kanade, H. Fujivoshi, D. Duggins, Y. Tsin, D. Tolliver, N. Enomoto, O. Hasegawa, P. Burt, and L. Wixson, “A System for Video Surveillance and Monitoring: VSAM Final Report,” Tech. report CMU-RI-TR-00-12, Carnegie Mellon University, 2000. In a similar system developed by Liu and Ahuja, shapes of fire in the video were also represented within frequency domain, as described in B. U. Toreyin, A. E. Cetin, A. Aksay, and M. B. Akhan, “Moving Object Detection in Wavelet Compressed Video,” Elsevier, Signal Processing: Image Communication, EURASIP, vol. 20, pp. 255-264, 2005 (hereafter “Signal Processing 2005”). Since Fourier transforms don't contain temporal information, these transforms should be performed inside previously established time frames. Within these time frames, length of the time frame plays a vital role. If length of the time frame is too long, not too many peaks may be obtained in fast Fourier transform data. If length of the time frame is not long enough, then no peaks may be obtained in fast Fourier transform data. However, VOC plumes exhibit variations over time that are random rather than according to a purely sinusoidal frequency. This means that Fourier domain methods are difficult to apply to VOC plume detection.

Volatile organic compounds are typically stored in containers and piped through systems using valves, connectors, pump joints, and similar equipment. While this equipment is designed so that the VOC remains contained within the system, there is potential for leakage at these valves, connectors, pump joints and the like. To detect leakage a detector is positioned in the vicinity of such equipment. At these locations, the detector makes separate measurements at each piece of equipment to determine whether or not there is a VOC plume. In the prior art gas leakage in the form of VOC plumes is detected using methods like gas chromatography, as described in Japanese Patent No. JP2006194776 for “Gas Chromotograph System and VOC Measuring Apparatus Using it” to Y. Tarihi, or oxidation as described in Patent No. WO2006087683 for “Breath Test for Total Organic Carbon”. However, these processes cause loss of time, effort and money at places, such as oil refineries, where there are many pieces of equipment that are likely to incur leakage.

Therefore there is a need for a VOC plume detection technology that is not constrained by the foregoing limitations of the prior art.

### SUMMARY OF THE INVENTION

The present invention uses two or more IR cameras and a visible range camera at the same time. A typical Long Wave IR (LWIR) camera covering 8 to 12 micrometers (LWIR8) and a Medium Wave IR (MWIR) covering 3 to 5 micrometers are used to monitor possible VOC gas leak areas. Some LWIR cameras cover a wider band of wavelengths from 7 to 15 micrometers (LWIR7). These LWIR and MWIR cameras are commonly available in the market. VOC gas vapors have unique absorption bands. Some of the gas vapors absorb IR energy only in the LWIR band and some of them absorb only in the MWIR band etc. For example, methane absorbs light only in the MWIR band, and propane vapor absorbs light in visible and LWIR bands. Therefore we can distinguish the nature of the VOC vapor by comparing visible, LWIR and MWIR images at the same time. The prior art fails to mention the use of wavelet analysis of regular, LWIR and MWIR camera images at the same time to detect VOC gas leaks. Another important feature of the present invention is that the MWIR and LWIR background wavelet images are matched and compared to each other in this invention.

An aspect of the invention is a method for determining the presence of VOC using visible range, Long Wave Infrared (LWIR) imaging 8 to 14 micrometers and Medium Wave Infrared (MWIR) imaging 3 to 5 micrometers videodata, comprising detecting gray scale value changes in the IR video images and comparing the corresponding visible range, LWIR and MWIR image frames to each other. In a further aspect of the invention the monitored scene is represented using MWIR, LWIR and visible range background images which are estimated from the videos generated by MWIR, LWIR and visible range cameras. In another aspect of the invention detecting a gray scale change further comprises detecting moving regions in a current video image and determining that the moving region has a decreased average pixel value in a region of the image in a white-hot mode infrared (IR) camera, and an increased average value in a region in a black-hot mode IR camera.

In yet another aspect of the invention detecting a VOC gas plume region comprises subtracting the current video images of visible range, MWIR and LWIR cameras from the estimated background images of visible range, MWIR and LWIR camera videos, respectively. It is also an aspect of the invention to determine that VOC gas plumes or poisonous ammonia and H2S plumes exist only if the moving region exists in two out of three spectral ranges imaged by the visible range, MWIR and LWIR cameras.

The present invention is a VOC plume detection method and system based on wavelet analysis of video. A system using the invention provides a cost effective alternative to flame ionization detectors which are currently in use to detect VOC leakages from damaged equipment components in petrochemical refineries. The method of the invention processes sequences of image frames (“video image data”) captured by visible-range and/or infrared cameras.

Several embodiments of the invention are described herein. One embodiment uses an adaptive background subtraction method to obtain a wavelet domain background image of the monitored scene, then uses a sub-band analysis for VOC plume detection, and optionally applies a threshold adaptation scheme. Another embodiment applies Markov modeling techniques to the intensity component of the raw picture data.

The invention discloses a method and system for determining the presence of volatile organic compounds (VOC) using video image data to detect a gray scale value change at a leakage site using wavelet analysis of the video image data. Moving regions in a current video image are detected, and then it is determined whether the detected moving region has decreased wavelet energy, or not. In one aspect, the invention provides for detecting moving regions in the scene by subtracting the current video image of a camera from an estimated background image of that camera. In other words, the present invention has a multi-channel (visible, MWIR, and LWIR channels) video processing capability. Two or more separate background images are estimated for visible range, MWIR and LWIR cameras depending of the number of cameras used in the system. In another aspect, the invention compares the estimated background images in MWIR and LWIR cameras to estimate the nature of the VOC gas leak.

In another aspect, the invention determines that a detected moving region has decreased wavelet energy by determining an average energy E_{Rs} of the detected moving region in the current video image, determining an average energy E_{Ro} of a corresponding region in an original image, and determining that the average energy difference |E_{Rs}−E_{Ro}| is less than a threshold value in each video channel. The threshold value is adaptively estimated to account for various VOC types and changes in lighting conditions.

A further aspect of the invention determines decreased wavelet energy of a detected moving region by detecting low sub-band image edges using a wavelet transform, using a three-state hidden Markov model to determine flicker for the detected moving region by analyzing an intensity channel in LL sub-band images, and selecting for the detected moving region a model having the highest value of probability of transition between states of VOC and non-VOC Markov models. Additionally, the invention provides for estimating contour and center of gravity of a detected moving region, computing a one-dimensional signal for a distance between the contour and center of gravity of the detected moving region in each video channel.

### BRIEF DESCRIPTION OF THE DRAWINGS

The foregoing and other objects, aspects and advantages will be better understood from the following detailed description of a preferred embodiment of the invention with reference to the drawings, in which:

FIG. 1A is a schematic showing an exemplar camera configuration for operation of the invention; FIG. 1B is a decision tree showing the logic of VOC determination; FIGS. 1C, 1D, 1E, 1F and 1G are graphs, adopted from NIST, showing the absorption spectra of ethane (FIG. 1C), methane (FIG. 1D), propane (FIG. 1E), ammonia (FIG. 1F), and H₂S (FIG. 1G).

FIG. 2 is a representation of a one level discrete-time wavelet transform of a two-dimensional image.

FIG. 3 is a representation of three-level discrete-time wavelet decomposition of the intensity component (I) of a video frame.

FIG. 4 is a modification of FIG. 3 to show checking of a wavelet transformed sub-band image by dividing the sub-band image LH1 into smaller pieces.

FIG. 5 is a schematic representation of three-state hidden Markov models, for regions with VOC (at left) and regions without VOC (at right).

### DETAILED DESCRIPTION OF PREFERRED EMBODIMENTS OF THE INVENTION

The present invention is an innovative device and system developed for detecting plumes of volatile organic compounds (VOC) in a plurality of images captured using both visible and infrared cameras.

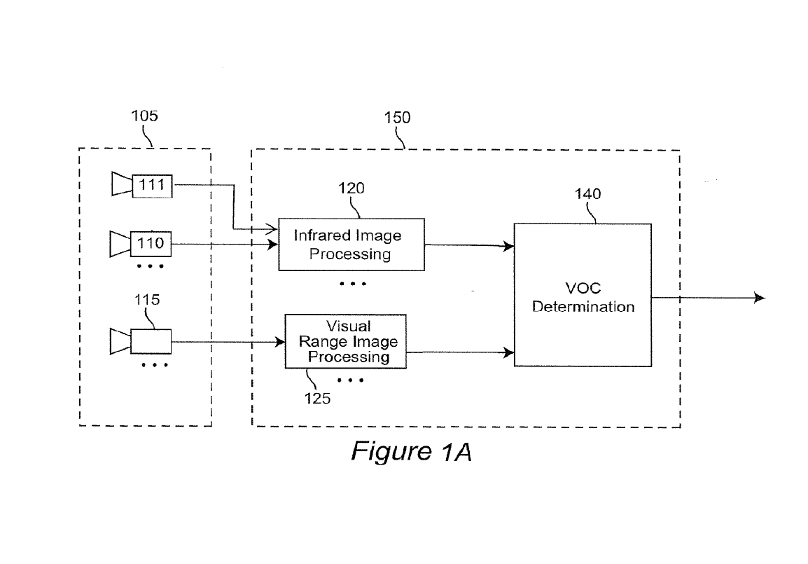

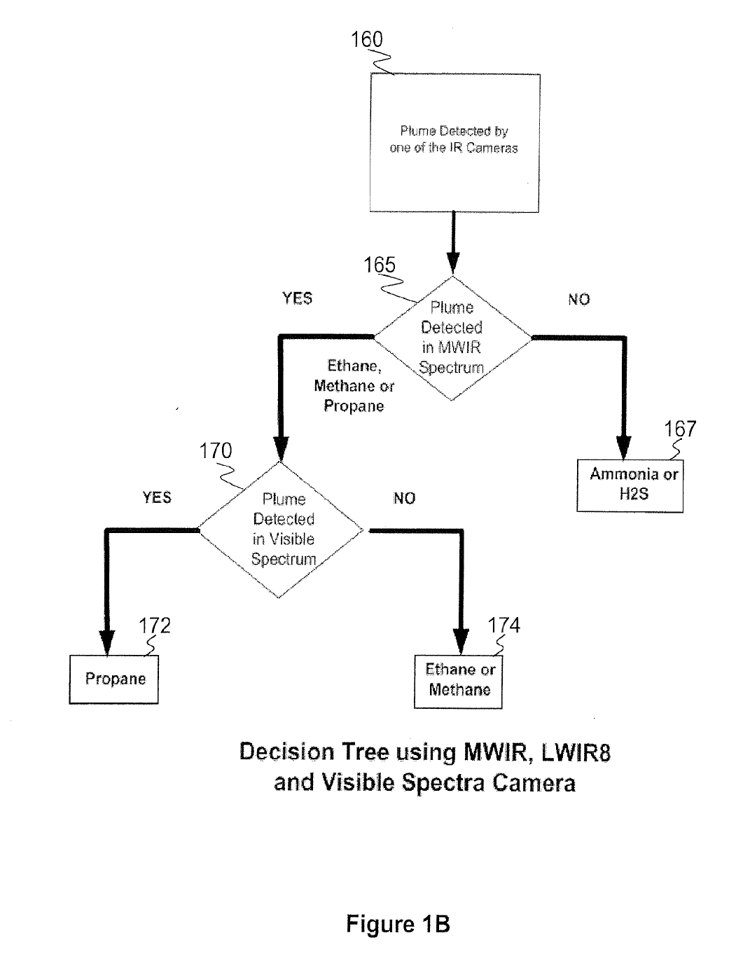

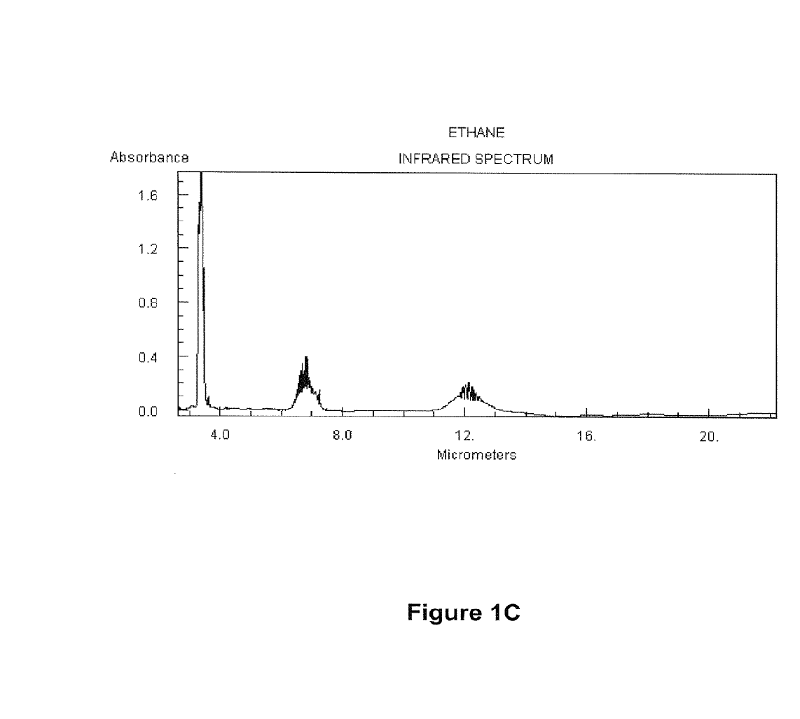

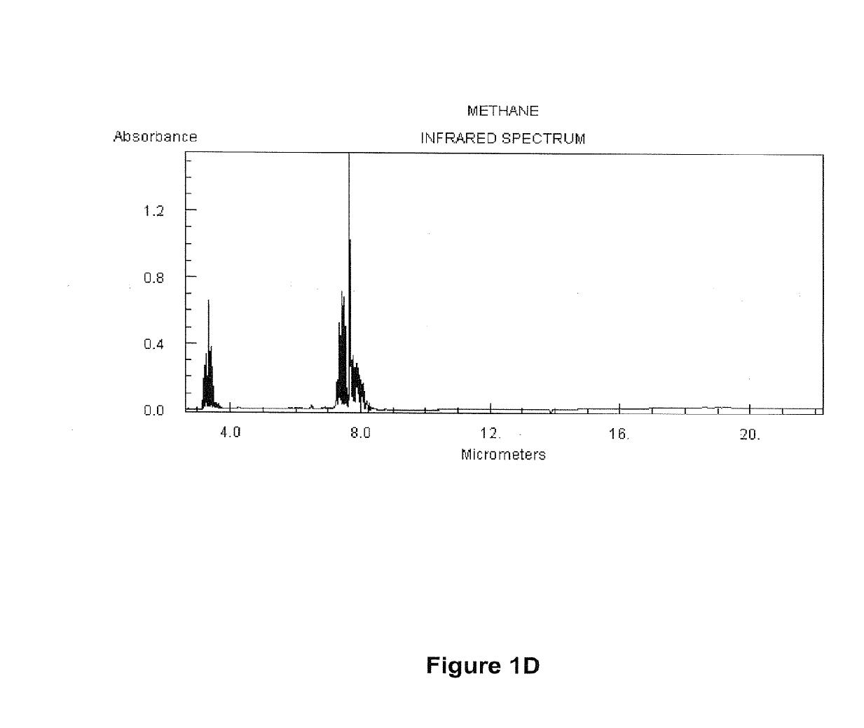

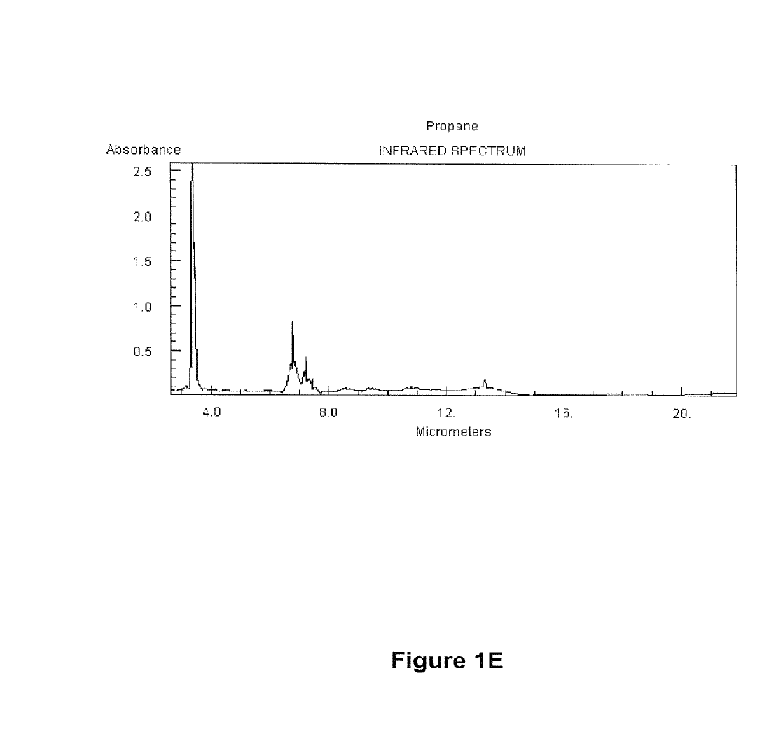

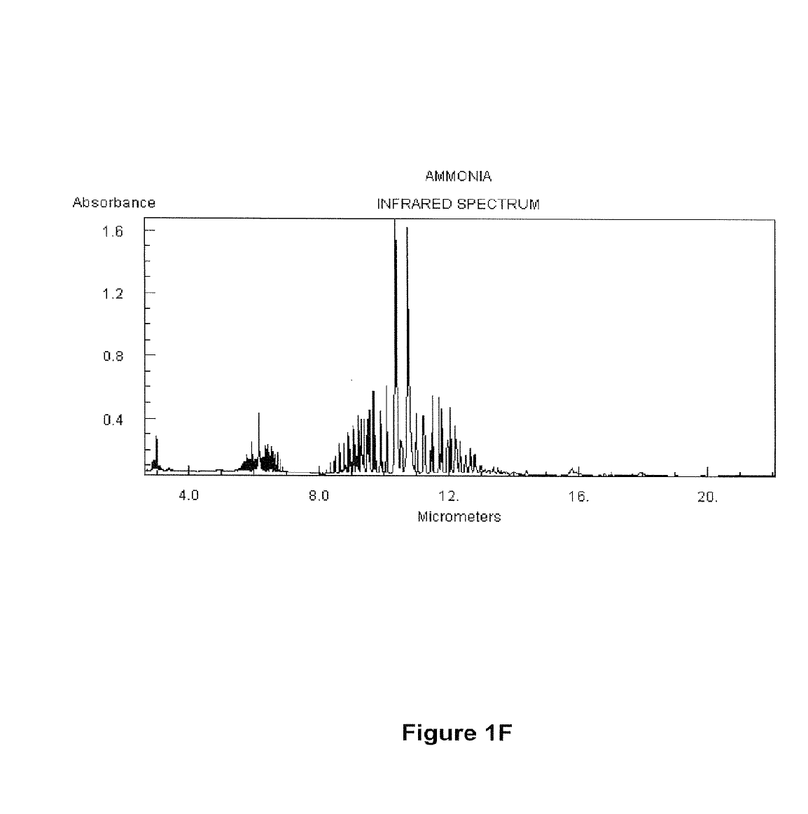

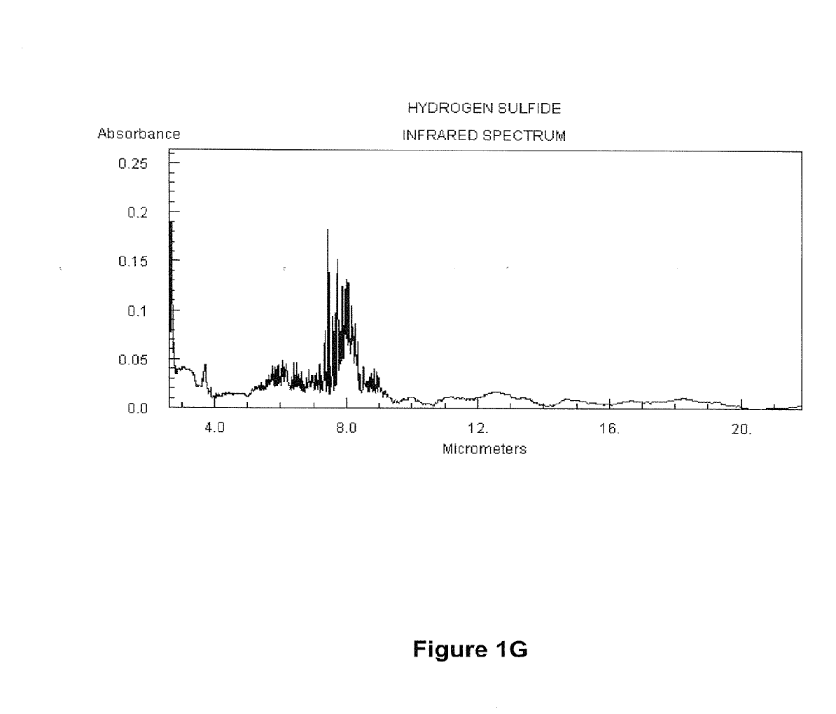

There are different types of fugitive VOC emissions with varying plume characteristics. For example, diesel and propane have vapor similar to smoke coming out of a pile of burning wood gasoline vapor, ethane, methane, ammonia, and the poisonous chemical H₂S vapors are transparent. They cannot be visualized in visible range videos. However, all of the vapors have flickering or turbulent plumes. As pointed out in Zhou 2007, the temperature of the VOC plume emitted from a leaking component drops during the initial expansion due to the absorption of IR energy of the background by the chemical. This causes a temperature difference between the VOC plume and the surrounding air. Each gas has specific IR absorption frequencies as shown in FIGS. 1C to 1G. Therefore an infrared camera whose range covers one of the absorption frequencies of a VOC vapor can produce an image of the VOC plume in spite of the fact that the vapor is invisible to the naked eye. It is not possible to visualize a VOC vapor whose absorption frequency is in the MWIR band with an infrared camera capable of imaging only the LWIR band.

Independent of the VOC type, plumes emitted from leaking components modify the background in image frames of the video. In IR videos, VOC vapor or H₂S and ammonia vapors decrease the values of pixels in a region of the image in a white-hot mode infrared (IR) camera, and an increased value in a region in a black-hot mode IR camera. There are other color mapping schemes in IR cameras such as where hot regions are marked red and cold regions are marked blue, etc. In general, IR video pixels are single valued numbers and most cameras map pixel values between 0 and 255. In white (black) hot mode, pixel value 255 (0) corresponds to white and 0 (255) corresponds to black. In the rest of this document we assume that the IR camera is in white-hot mode. Since a VOC plume covers the background it first softens the edges of the background and may completely block background objects after some time depending on the gas concentration.

This characteristic property of VOC plumes is a good indicator of their existence in the range of the camera. It is well known that edges produce local extrema in wavelet sub-images, as described in A. E. Cetin and R. Ansari, “Signal recovery from wavelet transform maxima,” IEEE Trans. on Signal Processing, v. 42, pp. 194-196, 1994, and S. Mallat, and S. Zhong, “Characterization of Signals from Multiscale Edges,” IEEE Trans. on PAMI, v. 14/7, pp. 710-732, 15 Jul. 1992. Degradation of sharpness in the edges results in a decrease in the values of these extrema. These extrema values, corresponding to edges, may or may not completely disappear when there is a VOC plume in the scene, depending on the gas concentration. Therefore a decrease in wavelet extrema values or wavelet domain energy is an indicator of VOC plumes in the monitored area.

Referring now to the drawings, and more particularly to FIG. 1, there is shown in schematic form operation of a VOC detection device in accordance with the invention. In the baseline VOC detection system shown in FIG. 1, infrared (IR) cameras MWIR 110 and LWIR8 111 are used, along with at least one visible range camera 115. The infrared cameras can monitor different bands of the infrared spectrum to detect the nature of the VOC leak. The coverage of LWIR8 starts at 8 micrometers. In more advanced systems an additional LWIR camera with a wider coverage (LWIR7, starting at 7 micrometers) is available. The infrared (IR) cameras 110, 111 generate a plurality of images, which are then analyzed 120.

Similarly, visible range camera 115 generates a plurality of images, which are then analyzed 125. The imaging results from both the infrared and the visible cameras are used to make a determination 140 whether or not VOC and H2S and ammonia plumes are present at a location corresponding to the images. The invention may be configured with a plurality of sensors 105, and implementation on a computer 150 will typically provide for multiple instances of VOC analysis (120,125). Determinations 140 will be applied to possible VOC detections at multiple physical locations covered by the images generated by the cameras (110,111,115).

### Adaptive Plume Detection

The first step in this embodiment of the VOC plume detection method is to detect changing regions in video, which is a common objective in video processing systems. Background subtraction is a standard method for moving object detection in video. The current image of the video is subtracted from the estimated background image for segmenting out objects of interest in a scene. In this invention a background image is estimated for each camera (or each video channel) and the backgrounds of IR cameras are matched to identify gas leaks. We use a particular method based on recursive background estimation in the wavelet domain to get an estimate of the background image, but other background estimation methods also can be used without loss of generality.

Let Iₙ(k,l) represent the intensity (gray scale) value at pixel position (k,l) in the nth frame of a video channel. Estimated background intensity value at the same pixel position, Bₙ₊₁(k,l) is calculated as follows:

$${B}_{n + 1} ( k , l ) = \{ \begin{matrix}{aB}_{n} ( k , l ) + ( 1 - a ) {I}_{n} ( k , l ) non \text{-} moving \\ {B}_{n} ( k , l ) , ( k , l ) moving\end{matrix} \qquad ( 1 )$$

where Bₙ(k,l) is the previous estimate of the background intensity value at the same pixel position. Initially, B₀(k,l) is set to the first image frame I₀(k,l). The update parameter a is a positive real number where 0<a<1. A pixel positioned at (k,l) is assumed to be moving if the brightness values corresponding to it in image frame Iₙ and image frame Iₙ₋₁ satisfy the following inequality:

|Iₙ(k,l)−Iₙ₋₁(k,l)|>Tₙ(k,l) (2)

where Iₙ₋₁(k,l) is the brightness value at pixel position (k,l) in the (n−1)-st frame Iₙ₋₁, and Tₙ(k,l) is a threshold describing a statistically significant brightness change at pixel position (k,l). This threshold is recursively updated for each pixel as follows:

$${T}_{n + 1} ( k , l ) = \{ \begin{matrix}{aT}_{n} ( k , l ) + ( 1 - a ) ( c \vert {I}_{n} ( k , l ) - {B}_{n} ( k , l ) ) , ( k , l ) ) non \text{-} moving \\ {T}_{n} ( k , l ) , moving\end{matrix} \qquad ( 3 )$$

where c>1 and 0<a<1. Initial threshold values are set to an empirically determined value.

The wavelet transform of the background scene can be estimated from the wavelet coefficients of past image frames, as is known in the art. When there is no moving object in the scene, the wavelet transform of the background image is stationary as well. On the other hand, foreground objects and their wavelet coefficients change in time. Therefore equations (1)-(3) also can be implemented in the wavelet domain to estimate the wavelet transform of the background image, which is also known in the art. Let Dₙ represent any one of the sub-band images of the background image Bₙ at time instant n: The sub-band image of the background Dₙ₊₁ at time instant n+1 is estimated from Dₙ as follows:

$${D}_{n +} ( i , j ) = \{ \begin{matrix}{aD}_{n} ( i , j ) + ( 1 - a ) {J}_{n} ( i , j ) , ( i , j ) non \text{-} moving \\ {D}_{n} ( i , j ) , moving\end{matrix} \qquad ( 4 )$$

where Jₙ is the corresponding sub-band image of the current observed image frame Iₙ. When the viewing range of the camera is observed for a while, the wavelet transform of the entire background can be estimated because moving regions and objects occupy only some parts of the scene in a typical image of a video and they disappear over time. Non-stationary wavelet coefficients over time correspond to the foreground of the scene and they contain motion information. In the VOC plume detection algorithm, Dₙ is estimated for the first level LL (low-low), HL (high-low), LH and HH sub-band images. These estimated background sub-band images are used in the sub-band based plume detection step described below.

The estimated sub-band image of the background is subtracted from the corresponding sub-band image of the current image to detect the moving wavelet coefficients and consequently moving objects, as it is assumed that the regions different from the background are the moving regions. In other words, all of the wavelet coefficients satisfying the inequality

|Jₙ(i,j)−Dₙ(i,j)|>Tₙ(i,j) (5)

are determined to be moving regions.

The next step in this embodiment is plume region detection. As discussed above, fugitive VOC plumes soften the edges in image frames independent of the VOC type. It is necessary to analyze detected moving regions further to determine if the motion is due to plume or an ordinary moving object. Wavelet transform provides a convenient means of estimating blur in a given region because edges in the original image produce high amplitude wavelet coefficients and extrema in the wavelet domain. When there is plume in a region wavelet extrema decrease. Therefore, (i) local wavelet energy decreases and (ii) individual wavelet coefficients corresponding to edges of objects in background whose values decrease over time should be determined to detect plume.

Let J_{n,LH}, J_{n,HL} and J_{n,HH} represent the horizontal, vertical and detail sub-bands of a single stage wavelet transform of the n-th image frame Iₙ, respectively. An indicator of the high frequency content of Iₙ is estimated by

$${E}_{h} ( {I}_{n} ) = {\sum }_{i , j}^{ } \vert {J}_{n , LH} \vert + {\sum }_{i , j}^{ } \vert {J}_{n , HL} \vert + {\sum }^{ } \vert {J}_{n , HH} \vert \qquad ( 6 )$$

The discrete-time wavelet domain energy measure E(I) can be computed using the Euclidian norm as well. However, the absolute value based L1 norm used in equation (6) is computationally more efficient because it does not require any multiplications. Similarly for the background image Bₙ:

$${E}_{h} ( {B}_{n} ) = {\sum }_{i , j}^{ } \vert {D}_{n , LH} \vert + {\sum }_{i , j}^{ } \vert {D}_{n , HL} \vert + {\sum }^{ } \vert {D}_{n , HH} \vert \qquad ( 7 )$$

The following inequality provides a condition for the existence of VOC plumes in the viewing range of the camera:

$${Δ}_{1} ( n ) = \frac{{E}_{h} ( {I}_{n} )}{{E}_{h} ( {B}_{n} )} < {T}_{1} \qquad ( 8 )$$

where the threshold T₁ satisfies 0<T₁<1.

Candidate plume regions are determined by taking the intersection of moving regions and the regions in which a decrease in local wavelet energies occur according to equation (8). These candidate regions are further analyzed in low-low (LL) sub-band images. Most of the energy of the plume regions in image frames is concentrated in low-low (LL) sub-band. Hence, the difference between the average energies of plume regions in the current frame and its corresponding LL sub-band image is expected to be close to zero.

Let a single stage wavelet transform be used for sub-band analysis. Let a candidate plume region, Rs, be determined in LL sub-band image, J_{n,LL} according to equations (5) and (8). Average energy of Rs is given as

$${E}_{Rs , n} = \frac{1}{4 N} {\sum }_{( i , j ) ∈ Rs}^{ } {\vert {J}_{nLL} ( i , j ) \vert}^{2} \qquad ( 9 )$$

where N is the total number of pixels in Rs. Average energy of the corresponding region, R₀ in the original image Iₙ is

$${E}_{Ro , n} = \frac{1}{4 N} {\sum }_{( k , l ) ∈ Ro} {\vert {I}_{n} ( k , l ) \vert}^{2} \qquad ( 10 )$$

Since the LL image is a quarter size of the original image, one needs to use a scaling factor of 4 to calculate the average energy of a pixel in equation (10). The candidate regions for which the difference between average energies is small are determined as plume regions:

Δ₂(n)=|E_{Rs,n}−E_{Ro,n}|<T₂ (11)

where T₂ is a threshold.

Thresholds T₁ and T₂ are not fixed. They are adaptively estimated to account for various VOC types and changes in the lighting conditions. An MLE (Maximum Likelihood Estimation) based threshold adaptation scheme has been implemented for this embodiment of the invention, and is similar to a method described in A. Ribeiro and G. B. Giannakis, “Bandwidth-constrained distributed estimation for wireless sensor networks—Part I: Gaussian case,” IEEE Trans. on Signal Processing, v. 54, pp. 1131-1143, 2006 (“Ribeiro 2006”).

The clairvoyant MLE estimator for decision functions Δ₁(n) and Δ₂(n), defined in equations (8) and (11), is simply the sample mean estimator. Based on this estimator threshold values T₁ and T₂ can be easily determined. However the thresholds may not be robust to changing environmental conditions.

Let us consider the problem of estimating a threshold T in an adaptive manner from observed images. We assume that the threshold values vary according to the following expression for each image

f[n]=T+w[n], n=0, 1, . . . ,N−1 (12)

where w[n]˜N(0,σ²) is zero-mean additive white Gaussian noise (AWGN) and n is image frame number.

For each image frame, plume detection functions Δₙ defines a binary image mask which is determined according to equations (8) and (11). One can also regard a binary mask as indicator variables defined by quantized observations f[n] with respect to the threshold T

b=(n)=1{f[n]ε(τ,+∞)} (13)

where τ is an initial parameter defining the mask b(n).
Each b(n) in equation (14) is a Bernoulli random variable with parameter

$$\begin{matrix}{q}_{k} ( T ) = Pr \{ b ( n ) = 1 \} = F ( τ - T ) \\ where & ( 14 ) \\ F ( x ) = 1 / ( \sqrt{2 π σ} ) {\int }_{x}^{+ ∞} exp [ - {u}^{2} / 2 {σ}^{2} ] d u & ( 15 )\end{matrix}$$

is the complementary cumulative distribution function of w[n]. In this case, the threshold is estimated in N=10 consecutive frames as follows

$$T = τ - {F}^{- 1} ( \frac{1}{N} {\sum }_{N = 0}^{N - 1} b ( n ) ) ,$$

which can be obtained as described in Ribeiro 2006.

In this embodiment of the invention, we have two indicator functions Δ₁(n) and Δ₂(n). A more general case can be formulated by defining two non-identical initial parameters for each of the thresholds, T₁ and T₂. This approach can be summarized in the following three steps:

1—Define a set of initial parameters τ={τᵤ|u=1, 2}

2—Obtain binary observations bᵤ; u=1, 2.

3—Find MLE for T.

Log-likelihood function is given as

$$L ( T ) = {\sum }_{n = 0}^{N - 1} {b}_{u} ( n ) ln ( {q}_{u} ( T ) ) + ( 1 - {b}_{u} ( n ) ) ln ( 1 - {q}_{u} ( T ) ) \qquad ( 16 )$$

from which the MLE of T can be defined as

\hat{T}=arg max_{T}{L(T)} (17)

Since T in equation (17) cannot be determined in closed-form, Newton's algorithm is utilized based on the following iteration:

$${\hat{T}}^{( i + 1 )} = {\hat{T}}^{( i )} - \frac{\dot{L} ( {\hat{T}}^{( i )} )}{\ddot{L} ( {\hat{T}}^{( i )} )} \qquad ( 18 )$$

where \dot{L}(x) and \ddot{L}(x) are the first and second derivatives of the log-likelihood function. Since the MLE problem defined by equations (16) and (17) is convex on T, the MLE in equation (18) is guaranteed to converge to the global optimum of L(T). These steps can be applied for both T₁ and T₂ separately.

The above mathematical operations described in Equations (1) through (18) are carried out for each video channel coming from IR cameras and the visible range camera.

### Comparison of MWIR and LWIR Background Images for Leak Estimation

Although they image the same scene LWIR and MWIR cameras provide different intensity values for each pixel because they monitor different IR bands. A plume region can be detected in an LWIR camera but it may not be detected in the MWIR camera for vice versa) depending on the VOC compound. Let R1 represent a group of pixel locations on which there is a VOC plume region in IR camera 1. The corresponding group of pixels in a second IR camera is determined. Average values of pixels in current image frames are determined. Let these values be m1, and m2, respectively. Also, average values of background image values in this region are determined. Let these values be mb1 and mb2, respectively. These values are used to estimate the VOC gas type. In the baseline VOC detection system shown in FIG. 1, MWIR 110, LWIR8 111 (whose coverage starts at 8 micrometers) and a visible range camera 115 are used. In more advanced systems an additional LWIR camera with a wider coverage (starting at 7 micrometers; LWIR7) is available.

Next, we present the detection method that we use to estimate typical chemicals in a refinery.

### Ethane (C2H6) Detection:

Ethane has a strong absorption peak around 3.5 micrometers and small peaks around 6.7 and 12 micrometers as shown in FIG. 1C adopted from the National Institute of Standards and Technology web site (http://webbook.nist.gov/chemistry/form-ser.html) (hereafter “NIST”). Therefore, an MWIR camera can detect the ethane leak but an LWIR camera may or may not detect the leak depending on the concentration. In a typical case, the MWIR video channel would detect the leakage plume but the LWIR camera will not detect any change in video pixels. If the leakage concentration is high LWIR may also produce a semi-transparent image of the plume. We will see that m1 is significantly lower than mb1 and m2 is almost equal to mb2 in general and in high concentrations m2 will be also smaller than mb2.

### Methane (CH4) Detection:

Methane has a strong absorption peak around 7.5 micrometers and a small peak at 3.5 micrometers as shown in FIG. 1D adopted from NIST. Therefore, while an LWIR camera covering 7 to 14 micrometers (LWIR7) can detect the methane leak an LWIR camera covering 8 to 14 micrometers (LWIR8) cannot detect the leak. Depending on the concentration, an MWIR camera can also detect the plume but not as strongly as the LWIR camera. For methane detection it is best to use three IR cameras. However, an LWIR camera with a range starting at 7 microns (LWIR7) and an MWIR camera also may be able to determine the existence of methane. In this case, we can use the ratios of average values to identify methane as follows

$$\frac{\vert m 1 - mb 1 \vert}{mb 1} > \frac{\vert m 2 - mb 2 \vert}{mb 2}$$

where m1 and mb1 are the average values of the current and background plume regions in the LWIR7 camera and m2 and mb2 are the average values of the current and background plume regions of the MWIR camera, respectively. If the above ratio does not hold then what has been detected may be an ordinary moving object rather than a plume of methane.

### Propane (C3H8) Detection:

Absorption spectrum of propane is shown in FIG. 1E. Propane is visible in a visible range camera. If a plume region is detected by both the regular camera and the MWIR camera it is a propane plume. It may also be detected by the LWIR camera when the concentration is high. In this case,

$$\frac{\vert m 1 - mb 1 \vert}{mb 1} < \frac{\vert m 2 - mb 2 \vert}{mb 2}$$

If this ratio does not hold then a propane plume has not been detected.

### Ammonia (NH4) Detection:

Absorption spectra of ammonia vapor is shown in FIG. 1F. An ammonia leak can be detected by an LWIR camera but it cannot be detected by MWIR cameras. If the concentration is high then we have

$$\frac{\vert m 1 - mb 1 \vert}{mb 1} >> \frac{\vert m 2 - mb 2 \vert}{mb 2}$$

where the sign “>>” means “much larger than”.

### H2S Detection:

Absorption spectra of poisonous H2S vapor is shown in FIG. 1G. It has two small absorption peaks at 7 and 8 micrometers. H2S absorbs less IR light compared to VOC compounds. It would be better to use two LWIR cameras with ranges starting from 7 and 8 microns, respectively. In this case

$$\frac{\vert m {1}_{8} - mb {1}_{8} \vert}{mb {1}_{8}} < \frac{\vert m {2}_{7} - mb {2}_{7} \vert}{mb {2}_{7}}$$

where m1₇ and mb1₇ are the average values of the current and background plume regions, respectively, in the LWIR camera with 7 micrometer detection capability (LWIR7) and m1₈ and mb1₈ are the average values of the current and background plume regions, respectively, of the LWIR camera whose coverage starts at 8 micrometers (LWIR8).

Based on the above information, we have the flowchart shown in FIG. 1B for gas leak detection in a refinery. Let us assume that a plume is detected 160 by one of the cameras of the multi-camera system. Then we apply the following algorithm to determine the nature of the leak in the baseline system. If the MWIR camera detects the plume 165 and the LWIR8 camera does not detect the plume, the plume is ethane, methane, or propane. If the plume is detected in the visible spectrum 170 it is propane 172, otherwise it is ethane or methane 174. However, if plume detection 160 is by the LWIR8 camera but not the MWIR camera 165, then the plume is ammonia or H₂S 167.

This logic may also be expressed in the following algorithm:

```
If (the MWIR camera detects the plume == true and
LWIR8 camera detects the plume == false)
{it is either ethane, methane, or propane leak
  If (the plume is detected by the visible range
camera == true)
    {it is a propane leak}
  Else
    {it is either ethane or methane.}}
If (the MWIR camera detects the plume == false and
LWIR8 camera detects the plume== true)
  {it is ammonia or H₂S leak}
```

In a more advanced implementation of the invention, the system of sensors 105 would include an LWIR7 camera. In such a case ethane and methane 174 can be distinguished from each other by comparing the MWIR and LWIR7 images. If the inequality

$$\frac{\vert m 1 - mb 1 \vert}{mb 1} > \frac{\vert m {2}_{7} - mb {2}_{7} \vert}{mb {2}_{7}}$$

is satisfied in a plume region it is methane. Otherwise the plume is due to a leak of ethane.
The use of LWIR7 camera can lead to the differentiation of ammonia and H2S 167 as well. If the inequality

$$\frac{\vert m {1}_{8} - mb {1}_{8} \vert}{mb {1}_{8}} < \frac{\vert m {2}_{7} - mb {2}_{7} \vert}{mb {2}_{7}}$$

is satisfied then the leak is due to H₂S. Since ammonia vapor does not absorb any IR light between and 8 micrometers the plume region in the LWIR7 camera will not be darker than the plume region in the LWIR8 camera and hence the inequality

$$\frac{\vert m {1}_{8} - mb {1}_{8} \vert}{mb {1}_{8}} < \frac{\vert m {2}_{7} - mb {2}_{7} \vert}{mb {2}_{7}}$$

will not be satisfied in the case of ammonia leaks.

### Markov Modeling of Intensity Component Data

In another embodiment, the invention operates by comparing the background image estimated by video data from visible 115 and infrared 110,111 cameras and the spatial wavelet transform coefficients of the current image frame. Any VOC gases being released right, at the instant of leakage have a semi-transparent characteristic. Due to this characteristic, they cause a decrease in sharpness of details inside the background image. The edges inside the background image are comprised by pixels that have high frequencies in this image. So, any decrease in energy of the edges inside this scene may constitute evidence for the presence of VOC gases in the video, provided that the edges do not totally disappear. All these data are used in making a final determination 140 that VOC leakage has been detected.

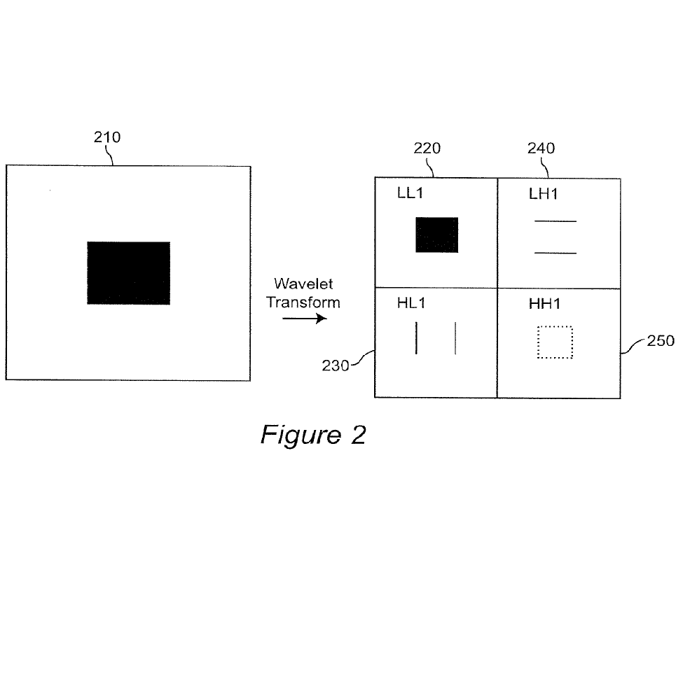

Wavelet transform is widely used in analyzing non-stationary signals, including video signals. This transform automatically reveals all extraordinariness of the signal it is applied to. When wavelet transform is applied to two-dimensional images or a video frame, it reveals all boundaries and edges of video objects inside the physical scene represented by the image. Turning now to FIG. 2, a wavelet transform divides an image 210 into various scales of sub-band images. Each sub-band image corresponds to a different frequency subset of the original image 210. Wavelet transforms exploit filter banks in order to process the pixels of picture images and to categorize them as being within low- and high-frequency bands. This process can be successively repeated until a desired level. First sub-band image 220 is called “Low-Low” and shown with LL. This image 220 contains the frequency information corresponding to ([0<ω1<π/2 and 0<ω2<π/2]), that is, the low frequency band along both the horizontal and the vertical path of the original picture 210. Similarly, “High-Low” sub-band image (HL) 230 contains high band horizontal and low band vertical frequency information corresponding to ([0<ω2<π/2 and π/2<ω1<π]) frequency bands; “Low-High” sub-band image (LH) 240 contains those information corresponding to ([0<ω1<π/2 and π/2<ω2<π]), that is, low band horizontal and high band vertical frequency information; and “High-High” sub-band image (HH) 250 corresponding to ([π/2<ω1<π and π/2<ω2<π]), that is, the high frequency band along both the horizontal (ω1) and the vertical (ω2) path.

The level of wavelet transform is identified by the number following this double-letter code. For example, as represented in FIG. 2, the sub-band image identified by LL1 220 corresponds to first level wavelet transform, and specifies the low-low sub-band image obtained by filtering the original images with a low-pass filter followed by horizontal (row-wise) and vertical (column-wise) down-sampling by 2.

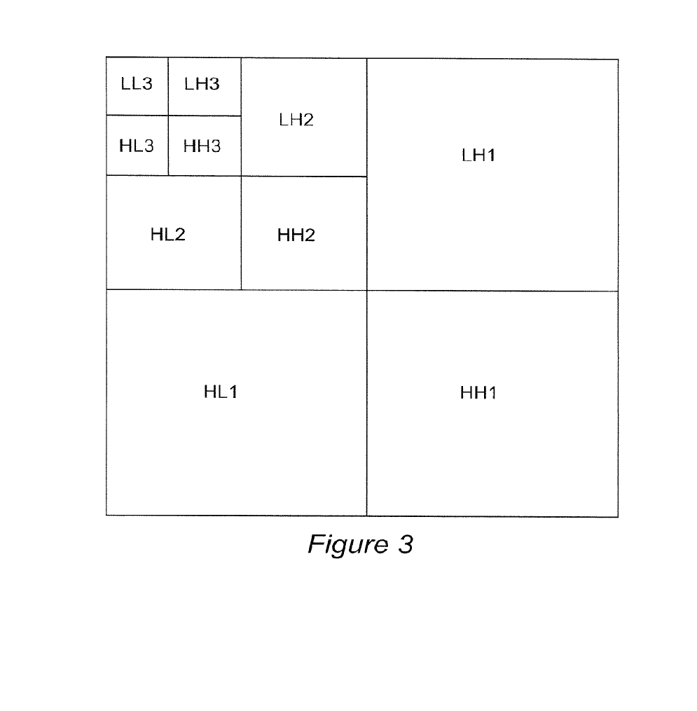

Wavelet transforms are generally applied at multiple levels. In this way, the signal, the image or the video frame that will be analyzed is decomposed into different resolution levels corresponding to different frequency bands. For example, third-level discrete wavelet transform of any image, I, is defined as WI={LL3, HH3, HL3, LH3, HH2, HL2, LH2, HH1, HL1, LH1} and is schematically represented by FIG. 3.

In this embodiment of the present invention, firstly the wavelet transform is applied to the black-and-white intensity (I) component of the raw picture data coming from the visible and infrared cameras. Each frame in infrared video signals is generally described by the intensity (I) channel. Then, the third-level wavelet transform is computed for this channel, as represented in FIG. 3.

Since the edge pixels in the scene yield local extrema on the wavelet domain, a decrease occurs at local extrema on the wavelet domain if VOC gases have been released into the scene. Thus a decrease may indicate presence of a VOC plume.

In this embodiment of the present invention, the method explained in Signal Processing 2005 was used for extraction of background images from infrared video frames. In accordance with the fundamental assumption taken as the basis for this method, the video data obtained from a stationary camera were used. After moving objects and background image in the infrared video are estimated, it is necessary to determine whether these moving regions correspond to a VOC plume or any other moving object. A volatile organic compound covers the edges in the background image, and causes these locations to appear more misty and hazy. But these edges correspond to local extrema on the wavelet domain. So, considering this fact, this embodiment of the invention identifies as VOC plumes the moving objects that cause a decrease in local extrema. Thus, by using wavelet sub-band images, VOC tracking becomes feasible.

High-frequency energy of a sub-image at any level n is kept inside a joint picture wₙ in the following formula:

wₙ(x,y)=|LHₙ(x,y)|²+|HLₙ(x,y)|²+|HHₙ(x,y)|² (19)

This picture wₙ is divided into blocks of dimensions (K1,K2) to compute the energy e(l1,l2) of each block:

$$e ( l 1 , l 2 ) = {\sum }_{( x , y )} {( {w}_{n} ( x + l 1 K 1 , y + l 2 K 2 ) )}^{2} \qquad ( 20 )$$

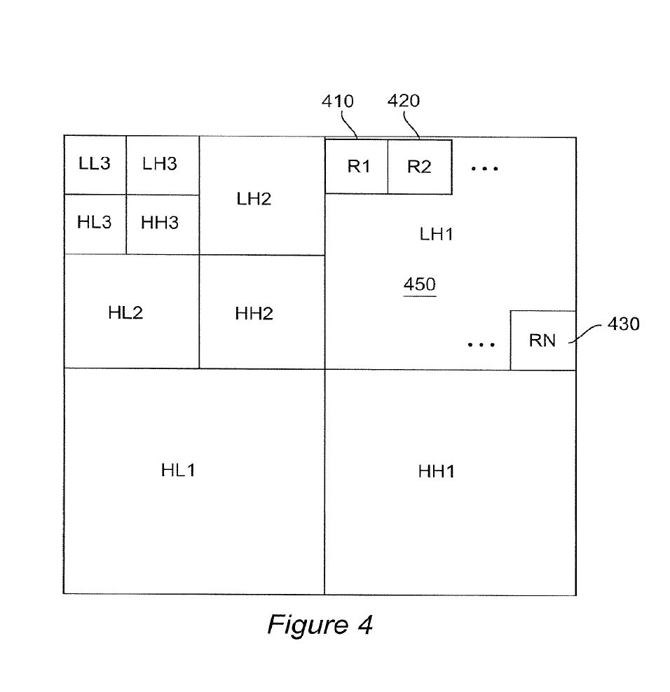

In this equation, (x,y)εRᵢ, and Rᵢ is the i^{th} block whose dimensions are (K1,K2). FIG. 4 illustrates blocks R₁, R₂ . . . and R_{N} (“R1” 410, “R2” 420, and “RN” 430) within the sub-image LH1 (item 450). In the preferred implementation of this embodiment of the invention, the size of blocks is specified to be 8×8 pixels. Local extrema of the wavelet transform of the current frame are compared with the highest local coefficient values of the wavelet transform of the background image, and if a decrease is observed in these values inside moving objects, this indicates a possible presence of VOC.

Flickering of volatile organic compounds during leakage from connectors is one of the fundamental features that can be used to separate these materials from ordinary objects in the infrared video. Especially, the pixels within the boundaries of VOC plumes disappear and reappear several times within a second, i.e. the pixels “flicker”. The VOC detection system of this embodiment of the present invention is based on determining whether this energy decrease in edges of the infrared images has a periodical and high-frequency characteristic or not. Flickering frequencies of pixels inside these regions are not fixed, and change with time. For this reason, in this embodiment of the present invention, the VOC flickering process is modeled with hidden Markov models.

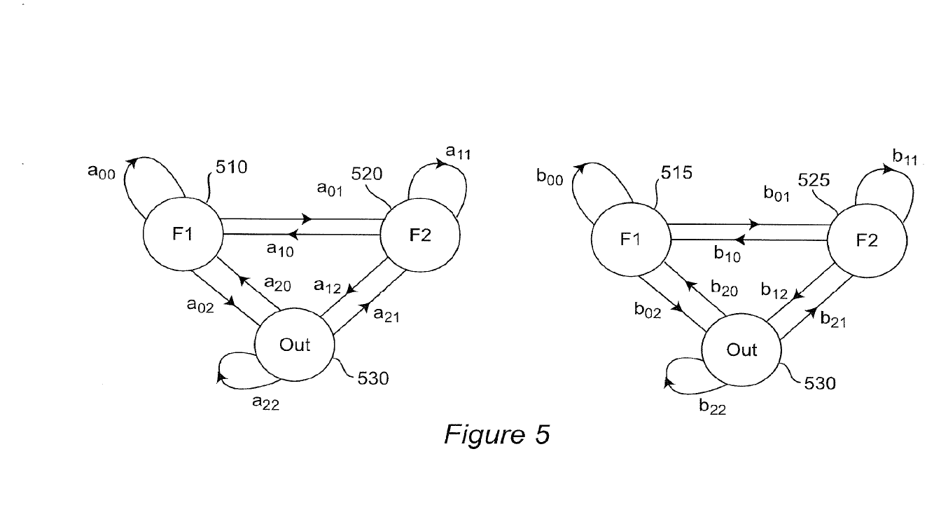

The first step is to detect energy decreases in low sub-band image edges. This is accomplished by wavelet transform based on equations (19) and (20), thereby identifying those regions with energy decrease. Then, the presence of a VOC plume is determined through three-state hidden Markov models, as represented by the schematic in FIG. 5. Hidden Markov models are trained with a feature signal defined as follows:

Let us use I(n) for the intensity channel value of a pixel inside the n^{th} video frame coming from the visible and the infrared cameras. Now, let us compute the absolute value of wavelet coefficients of the signal defined by I(n), and call it w(n). If we define two threshold values greater than zero, T1<T2, for these positive wavelet coefficients, we can define the states of Markov models by using these threshold values as follows: if w(n)<T1, the model is in “F1” state (510 for VOC, 515 for non-VOC), if T1<w(n)<T2 it is in “F2” state (520 for VOC, 525 for non-VOC), and if w(n)>T2 the model is in “Out” state (530 for VOC, 535 for non-VOC). The system developed with this model analyzes the VOC and non-VOC pixels temporally and spatially. Transition probabilities aᵢⱼ corresponding to VOC pixel models and bᵢⱼ corresponding to non-VOC pixel models, are estimated offline by using consecutive video frames. As shown in FIG. 5, the transition is represented from index i to index j, and the “F1”, “F2” and “Out” states are represented by the values 0, 1, 2, respectively, of these indices.

When a device in accordance with this embodiment of the invention is operated in real time by using visible and infrared cameras, the potential VOC plume regions are detected by analyzing the intensity channel in low-low (LL) sub-band images. The state of the Markov model of the pixels in these regions in each video frame is determined as explained in the above paragraph. Former Markov model states for each potential VOC pixel are stored for twenty consecutive video frames. A state sequence probability corresponding to this state history is computed by using probabilities of transition between states of VOC and non-VOC Markov models. The model generating the highest value of the probability is chosen.

Similarly, as regards spatial analysis, the pixels in potential VOC regions are horizontally and vertically scanned by using the same Markov models, and the model generating the highest value of probability is the basis for the determination 140 by the plume detection system whose schematic is shown in FIG. 1A.

In a system implementing this embodiment of the invention, wavelet transform analysis was conducted not only along VOC regions, but temporally and spatially inside VOC regions as well. The increase in energies of wavelet transform coefficients indicates an increase in motions with high frequency. For example, motion of an object that leads to an energy decrease in the edges of background image doesn't cause an increase in values of wavelet transform coefficients. This is because no temporal or spatial change occurs in values of pixels corresponding to these objects. However, pixels in actual VOC regions have both temporally and spatially high values of frequency band.

The next step in implementation of this embodiment of the invention is utilization of energy information of wavelet transform coefficients corresponding to potential VOC regions in frames coming from the visible and infrared cameras. For this purpose, contour and center of gravity of the potential VOC region are estimated. Then, the distance between the center of gravity and the contour of the region is computed in the range of 0≦θ<2π; and in this way a one-dimensional center-contour distance signal is generated. This signal has high frequency for those regions, such as VOC regions, whose contour changes over time; whereas it has low frequency for those regions whose boundaries change slowly over time or don't change at all. We can easily determine the high-frequency component of any spline by using one-level wavelet transform. If we use “w_{cntr}” for the wavelet transform coefficients corresponding to one-dimensional center-contour distance signal, and “c_{cntr}” for low-band coefficients; the ρ rate, which we call the ratio of wavelet transform energy to low-band energy, will, be as follows:

$$ρ = \frac{{\sum }_{n} \vert {w}_{cntr} ( n ) \vert}{{\sum }_{n} \vert {c}_{cntr} ( n ) \vert} \qquad ( 21 )$$

This formula can be used to indicate the presence of VOC plume within the field of view of the visible and infrared cameras. The rate p for VOC regions is high, whereas it is low for non-VOC regions.

The determinations made in accordance with the various steps explained above are used in making a final decision 140, as shown in FIG. 1, in a practical configuration of the invention there will be multiple sensors 105 (i.e. multiple infrared cameras 110 and multiple visual range cameras 115). Among multiple sensor data collection methods, we note the use of voting, Bayesian extraction and Dampster-Shafer methods. We will concentrate on voting-based decision-fusion methods for the present embodiment. But the other methods may also be used in this embodiment of the invention during the final decision making step 140.

One of the commonly used voting methods, the so-called “m-out-of-n” voting, is based on accepting the output in case m units out of n units of sensors agree with the same output. In another version of this voting, the so-called “T-out-of-v”, accepting the decision is based on the following inequality:

$$H = {\sum }_{i} {w}_{i} {v}_{i} > T \qquad ( 22 )$$

Here, wᵢ stands for the weights specified by the user, and vᵢ stands for the decisions of sensors, and T is a threshold value. Decision parameters of sensors can take binary values such as zero and one

### EXPERIMENTAL RESULTS AND CONCLUSIONS

The invention can be implemented on a personal computer (PC) with an Intel Core Duo CPU 1.86 GHz processor and tested using videos containing several types of VOC plumes including propane, gasoline and diesel. These video clips also can contain ordinary moving objects like cars, swaying leaves in the wind, etc.

The computational cost of the wavelet transform is low. The filter bank used in the implementation for single level wavelet decomposition of image frames have integer coefficient low and high pass Lagrange filters. Threshold updates are realized using 10 recent frames. Plume detection is achieved in real time. The processing time per frame is less than 15 msec for 320 by 240 pixel frames.

Gasoline has transparent vapor whereas diesel and propane have semi-transparent regular smoke like plumes both in visible band and LWIR (Long Wavelength Infrared) band. That is why it is more reliable to use both a regular camera (115) and an LWIR camera (111) for propane detection. Detection results for fixed and adaptive threshold methods for different VOC types are presented in Table 1, which shows VOC plume detection results for adaptive and non-adaptive threshold implementations. Threshold values are adjusted for gasoline type VOC plumes for the fixed threshold method in Table 1. Therefore, the detection performance for semitransparent VOC plumes is decreased as well as the number of false positives is higher. No false alarms are issued for regular moving regions such as people, cars, etc. when adaptive thresholds are used.

TABLE 1

| | Number | Number of detection | | Number of false | |
|---|---|---|---|---|---|
| | of Frames | frames | | positives | |
| | with | Adaptive | Non- | Adaptive | Non- |
| VOC Type | plume | thresholds | adaptive | thresholds | adaptive |
| Gasoline | 1241 | 1120 | 1088 | 0 | 0 |
| Diesel | 443 | 405 | 265 | 0 | 38 |
| Propane | 310 | 288 | 120 | 0 | 14 |

While the invention has been described in terms of preferred embodiments, those skilled in the art will recognize that the invention can be practiced with modification within the spirit and scope of the appended claims.

Having thus described our invention, what we claim as new and desire to secure by Letters Patent is as follows:

1. A method for determining the presence of volatile organic compounds (VOC) using video image data from a plurality of cameras, comprising:
obtaining video image data from each of a plurality of cameras, each camera having sensitivity to a particular spectral range, no two of said spectral ranges being the same;
detecting gray scale value changes in the video images of each camera;
comparing image frames of the respective cameras corresponding to the gray scale value changes; and
identifying from said comparing a signature corresponding to one or more particular volatile organic compounds.

2. The method of claim 1, wherein the plurality of cameras comprise a visible range camera, a Long Wave Infrared (LWIR) camera imaging 8 to 14 micrometers and a Medium Wave Infrared (MWIR) camera imaging 3 to 5 micrometers.

3. The method of claim 2, wherein a monitored scene is represented using background images which are estimated from the videos generated by the respective MWIR, LWIR and visible range cameras.

4. The method of claim 2, wherein detecting a gray scale change further comprises:
detecting moving regions in a current video image; and
determining that said moving region has a decreased average pixel value in a region of the image in a white-hot mode infrared (IR) camera, and an increased average value in a region in a black-hot mode IR camera.

5. The method of claim 3, wherein detecting a VOC gas plume region comprises subtracting the current video images of the respective cameras from the said estimated background images of the respective cameras.

6. The method of claim 2, wherein either VOC gas plumes or poisonous ammonia and H2S plumes exist if the moving region exists only in two out of three spectral ranges imaged by the visible range, MWIR and LWIR cameras.

7. The method of claim 2, wherein the type of the VOC gas leak can be estimated using MWIR, LWIR and visible range camera images using an algorithm consisting of the following steps:
```
If (the MWIR camera detects the plume == true and LWIR
camera detects the plume == false)
    {the type is either ethane, methane, or propane
        If (the plume is detected by the visible range
        camera == true)
      {the type is propane}
  Else
      {the type is either ethane or methane}}.
```

8. The method of claim 2, wherein poisonous ammonia vapor and H2S vapor leaks can be determined using MWIR, LWIR and visible range camera images using an algorithm consisting of the following steps:
If (the MWIR camera detects the plume==false and LWIR camera detects the plume==true)
then {vapor leak is ammonia or H2S}.

9. The method of claim 8, wherein ammonia and H2S leaks are distinguished from each other by using an LWIR camera with imaging capability starting at 7 micrometers and by calculating the inequality |m18−mb18|/mb18<|m17−mb17|/mb17 where m17 and mb17 are the average values of the current and background plume regions in the LWIR camera with 7 micrometer detection capability (LWIR7) and m18 and mb18 are the average values of the current and background plume regions of the LWIR camera whose coverage starts at 8 micrometers, H2S being identified if the inequality is satisfied and ammonia being identified if the inequality is not satisfied.

10. The method of claim 7, wherein ethane and methane camera with imaging capability starting at 7 micrometers (LWIR7) and by calculating the inequality |m1−mb1|/mb1>|m2−mb2/mb2 where m1 and mb1 are the average values of the current and background plume regions in the LWIR7 camera and m2 and mb2 are the average values of the current and background plume regions of the MWIR camera, respectively, methane being identified if the inequality is satisfied and ethane being identified if the inequality is not satisfied.

11. A system for determining the presence of volatile organic compounds (VOC) using video image data from a plurality of cameras, comprising:
means for obtaining video image data from each of a plurality of cameras, each camera having sensitivity to a particular spectral range, no two of said spectral ranges being the same;
means for detecting gray scale value changes in the video images of each camera;
means for comparing image frames of the respective cameras corresponding to the gray scale value changes; and
means for identifying from said comparing a signature corresponding to one or more particular volatile organic compounds.

12. The system of claim 11, wherein the plurality of cameras comprise a visible range camera, a Long Wave Infrared (LWIR) camera imaging 8 to 14 micrometers and a Medium Wave Infrared (MWIR) camera imaging 3 to 5 micrometers.

13. The system of claim 12, wherein a monitored scene is represented using background images which are estimated from the videos generated by the respective MWIR, LWIR and visible range cameras.

14. The system of claim 12, wherein the means for detecting a gray scale change further comprises:
means for detecting moving regions in a current video image; and
means for determining that said moving region has a decreased average pixel value in a region of the image in a white-hot mode infrared (IR) camera, and an increased average value in a region in a black-hot mode IR camera.

15. The system of claim 13, wherein means for detecting a VOC gas plume region comprises means for subtracting the current video images of the respective cameras from the said estimated background images of the respective cameras.

16. The system of claim 12, wherein either VOC gas plumes or poisonous ammonia and H2S plumes exist if the moving region exists only in two out of three spectral ranges imaged by the visible range, MWIR and LWIR cameras.

17. The system of claim 12, wherein the type of the VOC gas leak can be estimated using MWIR, LWIR and visible range camera images using an algorithm consisting of the following steps:
```
If (the MWIR camera detects the plume == true and LWIR
camera detects the plume == false)
    {the type is either ethane, methane, or propane
      If (the plume is detected by the visible range
      camera == true)
    {the type is propane}
  Else
    {the type is either ethane or methane}}.
```

18. The system of claim 12, wherein poisonous ammonia vapor and H2S vapor leaks can be determined using MWIR, LWIR and visible range camera images using an algorithm consisting of the following steps:
If (the MWIR camera detects the plume == false and LWIR
camera detects the plume == true)
then {vapor leak is ammonia or H2S}.

19. The system of claim 18, wherein ammonia and H2S leaks are distinguished from each other by using an LWIR camera with imaging capability starting at 7 micrometers and by calculating the inequality |m18−mb18|/mb18<|m17−mb17|/mb17 where m17 and mb17 are the average values of the current and background plume regions in the LWIR camera with 7 micrometer detection capability (LWIR7) and m18 and mb18 are the average values of the current and background plume regions of the LWIR camera whose coverage starts at 8 micrometers, H2S being identified if the inequality is satisfied and ammonia being identified if the inequality is not satisfied.

20. The system of claim 17, wherein ethane and methane plumes are distinguished from each other by using an LWIR camera with imaging capability starting at 7 micrometers (LWIR7) and by calculating the inequality |m1−mb1|/mb1>|m2−mb2|/mb2 where m1 and mb1 are the average values of the current and background plume regions in the LWIR7 camera and m2 and mb2 are the average values of the current and background plume regions of the MWIR camera, respectively, methane being identified if the inequality is satisfied and ethane being identified if the inequality is not satisfied.
